(19) United States
(12) Patent Application Publication
(10) Pub. No.: US 2002/0101610 A1
(43) Pub. Date: Aug. 1, 2002

(54) Printing system

(76) Inventor: Dirk Winne, Loppem (BE)

Correspondence Address: PENNIE & EDMONDS LLP, 1667 K STREET NW, SUITE 1000, WASHINGTON, DC, 20006

(21) Appl. No.: 09/919,842

(22) Filed: Aug. 2, 2001

(30) Foreign Application Priority Data
Jan. 30, 2001 (GB) 0102360.5

(51) Int. Cl. G06F 15/00

(52) U.S. Cl. 358/1.15

(57) ABSTRACT

A printing system is described which has a printer unit with a housing in which a print head is mounted for movement over a print face defined by the housing and a base station arranged to receive the printer unit. The base station has an opening for receiving paper or the like such that the paper is adjacent the print face. A printing operation can be executed when the printer unit is in the base station.

A print processor can be connected to the printing unit, the print processor storing information to be printed in a memory unit such that if printing of a sequence of images is interrupted, it can be re-established from the store.

A method of selecting a symbol to be printed is also described, where a plurality of subsets of symbol types are displayed, a subset being selected based on display of a particular symbol and wherein subsequently the symbols of the subset are sequentially displayed such that a particular symbol can be printed.

### FIELD OF THE INVENTION

The present invention relates to printing systems and in particular printing systems comprising a printing unit and a base station.

### BACKGROUND OF THE INVENTION

Printing systems are already known that comprise an electronic printing unit and a base station. Such printing systems are most commonly used for printing short, predefined messages or information onto existing documents in a manner analogous to using a rubber stamp. For example, such printing systems may be used to print “Confirmation Copy” on a letter originally sent by facsimile. Such printing systems are more versatile over previously used rubber stamps because a number of different messages may be printed by the same printing system, thus eliminating the need to store a large number of rubber stamps.

A known printing system is described in our earlier Application No. ______ where text and image to be printed can be conveyed electronically to, or stored in an electronic medium at, the printing unit. The printing unit comprises a fixed housing with an open face aligning a print location within which an ink jet point head is movable in two dimensions to print an image.

For known printing systems to print the desired message or information, the user must remove the printing unit from the base station and place the printing unit onto an existing document at a position in which the information is desired to be printed. Such systems thus suffer the disadvantage that to perform a printing operation a number of different steps must be completed i.e. physically placing the printing unit on the document, ensuring that the document is aligned to the printing unit such that information is printed at the desired location on the document and physically removing the printing unit from the document after printing.

It would therefore be advantageous to provide a printing system that did not suffer from this disadvantage.

### SUMMARY OF THE INVENTION

According to one aspect of the present invention there is provided a printing system comprising a printer unit having housing in which a print head is mounted for movement over a print face defined by the housing and a base station arranged to receive said printer unit, said base station having an opening for receiving an image receiving medium, said opening being located within said base station such that at least a portion of said image receiving medium received within said opening is adjacent said print face, wherein a printing operation can be executed when the printer unit is received in said base station.

Preferably the base station comprises a sensor arranged to provide a detection signal in response to an image receiving medium being placed within said opening and in response to the detection signal the printer unit executes a printing operation a predefined timed time period after the detection signal is provided.

Alternatively, in response to the detection signal a confirmation signal may be provided to indicate that a printing operation may be manually initiated. The confirmation signal may be a visual signal or an audio signal.

Preferably the base station comprises an alignment device having alignment guides whereby alignment of the image-receiving medium in the opening with the alignment guides facilitates alignment of the image-receiving medium with the print face. The alignment device may comprise at least two alignment guides whereby each of the alignment guides facilitates alignment of a different sized image-receiving medium.

According to another aspect of the present invention there is also provided a method of selecting a symbol to be printed by a printer unit from a set of symbols, said set of symbols comprising a plurality of subsets of symbol types, each subset comprising a plurality of symbols of one type, the method comprising: sequentially displaying a first symbol from one or more of said subsets of symbol types and selecting a said subset when a desired symbol type is displayed; sequentially displaying the symbols comprising said selective subset and selecting a desired symbol to be printed.

Each subset can comprises a plurality of alphabetic characters, a plurality of numeric characters, or a plurality of special characters including a number of punctuation symbols and a number of mathematical symbols.

Preferably each of the alphabetic subsets comprises a plurality of symbols, each symbol being a different representation of the same alphabetic character.

Preferably the sequential display steps are performed in response to the operation of one or more scroll keys located on said printer unit. Two scroll keys may be provided, a first scroll key causing the sequential display steps to be formed in a first sequence and a second scroll key causing the sequential display steps to be formed in a second sequence.

Preferably the selecting operations are executed by the activation of a select key located on said printer unit.

According to another aspect of the present invention there is further provided a printing system comprising a printing unit connected to a print processor, said print processor arranged to generate a sequence of images to be printed, and said printing unit comprising a communication unit operable to communicate to said print processor information relating to the previously printed image whereby said print processor is further operable to store said communicated information in a memory unit wherein if printing of said sequence of images is interrupted printing can be resumed at the point in the sequence at which the interruption occurred at.

Preferably the sequence of images includes at least one data item having a value that varies in consecutive images in the sequence in a predefined manner and the information communicated from the printing unit to the print processor comprises the value of the at least one data item.

Preferably the information communicated from the printing unit to the print processor comprises the number of images in the sequence that have been printed.

Preferably the communication unit communicates the information to the print processor after each of the images has been printed.

Preferably the communication unit communicates the information to the print processor whenever printing is interrupted.

For a better understanding of the present invention and to show how the same may be carried into effect, reference will now be made by way of example to the accompanying drawings.

### BRIEF DESCRIPTION OF THE DRAWINGS

FIG. 1 shows the printing system according to an embodiment of the present invention;

FIG. 2 shows a view of the bottom of the print unit shown in FIG. 1;

FIG. 3 shows a perspective view of the print head and cleaning station of the print unit shown in FIGS. 1 and 2;

FIG. 4 shows a diagrammatic representation of the scrolling scheme of an embodiment of the present invention;

FIG. 5 shows a printing system according to a further embodiment of the present invention; and

FIG. 6 shows an alternative arrangement of the printing system shown in FIG. 1.

### DESCRIPTION OF THE PREFERRED EMBODIMENTS

Unless otherwise stipulated, like reference numerals refer to like parts on all the drawings.

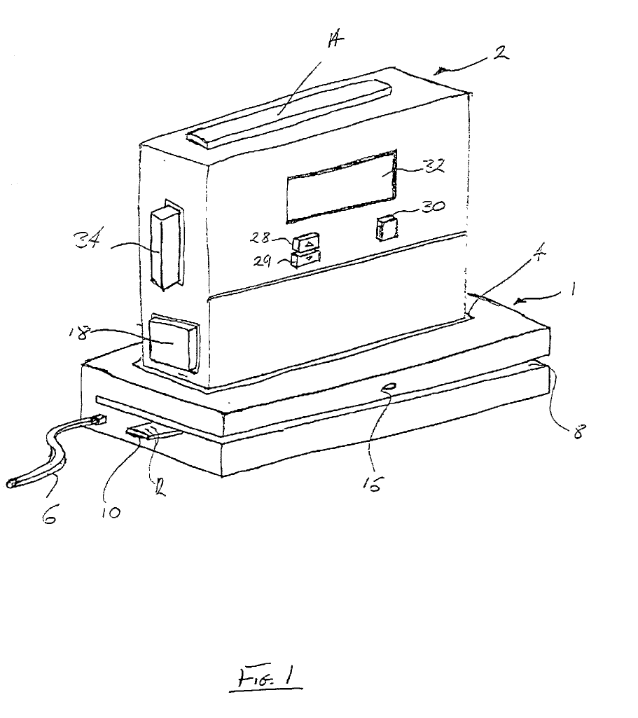

FIG. 1 shows a perspective view of a printing system according to an embodiment of the present invention. The system comprises a base station 1 and a print unit 2. In the embodiment shown, the base station 1 is substantially rectangular in shape, although it will be appreciated by those skilled in the art that other shapes would equally suffice. In use, the base station is intended to be placed on a work surface such as a desk, or the like. In what is thus the uppermost surface of the base station 1 there is located a recess 4. The recess 4 is shaped to receive a correspondingly shaped portion of the print unit 2. As shown in FIG. 1, the print unit 2 is also substantially rectangular, although again, it will be appreciated by those skilled in the art that the print unit may be of virtually any shape provided that the recess 4 within the base station 1 is correspondingly shaped to receive the appropriate portion of the print unit. The base station 1 is connectable to a power supply via a power cable 6. The base station 1 also comprises a slot 8 that is dimensioned to be able to receive an image receiving medium of a most commonly used size, for example A4. The slot 8 may extend across the full width of the base station 1, as shown in FIG. 1, or the base station 1 may be of such a size that the slot 8 forms a discrete opening within the base station, in a manner similar to a letter box. At this point it will be noted that whilst the term “image receiving medium” encompasses any medium on which printing may be effected, for convenience sake the term “paper” will be used hereinafter. The slot 8 extends sufficiently into the base station 1 such that at least a portion of it extends under the print unit 2 when the print unit is located within the recess 4 of the base station 1. The recess 4 extends through the base station 1 such that it communicates with the slot 8. However, means are provided (not shown) to prevent the print unit 2 from resting on the lower surface of the slot 8 when the print unit 2 is located within the recess 4 of the base station 1.

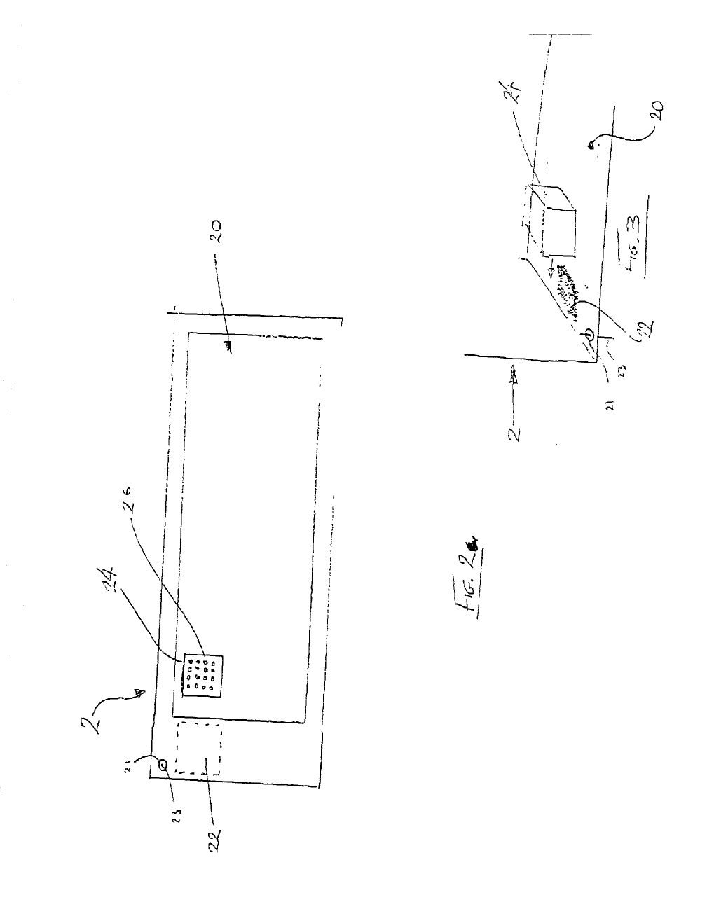

The bottom surface of the print unit 2, that is the surface that is inserted into the recess 4 of the base station 1, is illustrated in FIG. 2. Located in the bottom surface of the print unit 2 is an aperture 20, or print face, that defines the area over which printing may be executed by the print unit 2. Located within the print face 20 is a print head 24, which in the embodiment shown, is of the ink jet type and comprises a plurality of individual ink drop outlets 26 that allow a discrete image to be created, for example a single alphanumeric character. The print head 24 is moveable by transport means (not shown) such that it may move across the plane of the print face 20 in two orthogonal directions. This allows a plurality of lines of images to be generated by the printer 24 such that a plurality of lines of discrete characters may be printed or alternatively characters larger than the print head 24 itself may also be generated. It will be appreciated that the print head 24 may also be limited to movement across the print face 20 in a single direction only, thus only having the ability to print a single line of characters.

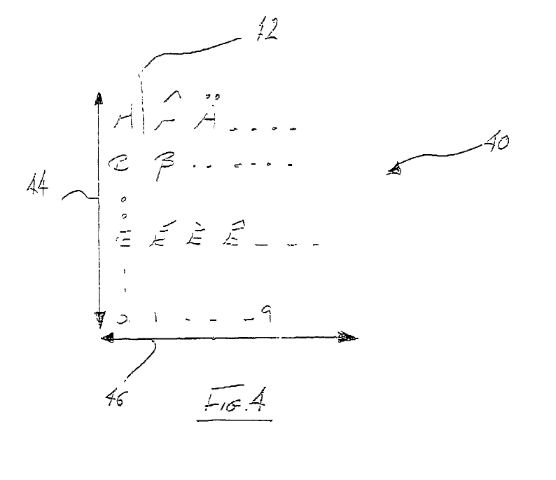

The print face 20 does not extend across the entirety of the lower surface of the print head 2 and located on part of a remaining portion of the lower surface and located within the body of the print unit 2, is a print head cleaning station 22. The print head 24 is moveable to the print head cleaning station 22 and in doing so effects a cleaning operation on the lowermost surface of the print head 24. The print head cleaning station 22 may comprise a pad of felt or other similar absorbent material that removes any excess printing fluid from the printer 24 when it is brought into registration with the print head cleaning station 22. Such a pad of absorbent material is shown in FIG. 3, which shows an enlarged view of the print head cleaning station and print head of FIG. 2.

To execute a printing operation on a piece of paper or document the print unit 2 may be removed from the recess 4 in the base station 1 and placed on the piece of paper so that the print face is at the location at which the printing is desired to appear. The printing operation is then manually initiated by depressing the print button 14 located on the uppermost surface of the print unit 2. The print unit 2 may then be returned to the base station 1. Whenever the print unit 2 is replaced in the base station 1 a sensor, for example a microswitch, (not shown) located within the recess 4 of the base station 1, detects the presence of the base station 2 and causes the print unit 2 to execute a print head cleaning operation. A print head cleaning operation is executed by the print head 24 of the print unit 2 being driven across the print head cleaning station 22, thereby removing any excess printing fluid from the print head 24.

It will of course be appreciated that there is no necessity to replace the print unit 2 in the base station 1 after each printing operation has been completed. The print unit 2 may simply be placed on the work surface until required again. If the print unit is not returned to the base station 1 a signal may be generated by the print unit that indicates to the user that the print unit should be replaced on the base station 1. This signal may be generated either after a predetermined time period after the last printing operation has been executed, or after a predetermined number of printing operations have been executed, and has the purpose of reminding the user to replace the print unit 2 in the base station 1 to enable a print head cleaning operation to be executed, thus avoiding the print head from drying out, or becoming clogged with printing fluid. The signal denoted the headcleaning signal, may either be a visual signal or an audio signal.

An alternative method of printing onto a piece of paper or document is also possible with embodiments of the present invention. According to this mode of operation the print unit 2 remains, or is replaced, in the recess 4 of the base station 1 and a piece of paper or a document is introduced into the slot 8 within the base station 1. The paper is fully introduced into the slot 8 such that it underlies the print face of the print unit 2 that is located in the recess 4 of the base station 1. A sensor may be provided within the base station 1 that detects when a piece of paper has been introduced into the slot 8. The sensor may be, for example, a simple light emitting diode/photo receptor arrangement that simply detects the insertion of a piece of paper into the slot 8, or it may be a micro switch located at the far extremity of the slot 8 and arranged to be activated by the leading edge of the paper that is introduced into the slot. The sensor produces a signal when a piece of paper is detected in the slot 8, the signal alternatively either being transmitted to the print unit 2 and causing a print operation to be executed automatically, or may cause a audible or visual signal to be generated by the printing system as confirmation to the user that the printing operation may be initiated by depressing the print operation button 14. In the embodiment shown in FIG. 1 an LED 16 is shown on the base station 1 that provides a visual confirmation signal.

To assist in aligning the paper introduced into the slot 8 an alignment device 10 is provided on the base station 1 and comprises an essentially flat element attached to the base station 1 so that an edge of a piece of paper inserted into the slot 8 closely overlies a portion of the alignment device 10. The alignment device includes at least one alignment mark 12 that is positioned on the alignment device such that when the edge of a piece of paper of a normal size, for example A4 or quarto, is aligned with the alignment mark 12 the printing operation will be executed in the center of the piece of paper, or document.

In some embodiments of the present invention the alignment device 10 may be removable from the base station 1 such that other alignment devices corresponding to other sizes of pieces of paper, for example envelopes, may be inserted to facilitate the alignment of the print unit 2 with such other sized pieces of paper.

It will thus be apparent to those skilled in the art that by providing a printing system that allows a printing operation to be executed without the removal of the print unit 2 from the base station 1 a printing system is provided that is easier and more convenient to use.

The print unit 2 may be connected to the base station 1 by a power cable (not shown) that conveys power from the base station to the print unit, enabling operation of the print unit 2. However, as this restricts the possible range of movements of the print unit 2 in relation to the base station 1, a more preferred arrangement is that the print unit 2 incorporates a battery pack 18. The battery pack 18 may be arranged to receive conventional batteries in a known manner to provide power to the print unit 2, or may comprise, or be arranged to receive, a rechargeable battery unit. In this latter case the base station 1 may incorporate a power connector (not shown) that engages with a corresponding connector (not shown) on the print unit 2 such that the battery pack 18 may receive a recharging current via the base station 1 whenever the print unit 2 is located within the recess 4 of base station 1.

To increase the usefulness of the printing system of the present invention the system is arranged to be capable of printing a number of different information items. Examples of information items that may be printed include “Confidential”, “Received”, the current time and/or date, or even a bar code. The print information required to drive the print head 24 of the print unit 2 to print such information items is stored in a memory unit within the print unit 2. To select the information item that is required to be printed scroll buttons 28;29 and a select button 30 are provided on a face of the print unit 2 and are used in conjunction with a display 32, also mounted on the print unit 2. The scroll buttons 28;29 are operated by the user to sequentially display on the display 32 the desired data items that may be printed. When the desired data item is displayed it is selected by the use of the select button 30. Any subsequent printing operation will cause the selected data item to be printed. In addition to, or instead of, the memory unit within the print unit 2 the print unit 2 may be arranged to receive a memory card 34 of a known type, the memory card containing the information items to be printed, or alternatively additional data items that may be printed. It is envisaged that the data items held on the data memory card 34, or the memory unit within the print unit 2, are predetermined items selected by the manufacturer. It will also be appreciated that a number of different memory cards 34 may be supplied, each bearing different data items covering a wide range of applications.

The scroll buttons 28;29, select button 30 and display screen 32 can also be used to select or adjust the print properties of the printed data items or certain functions of the print unit 2. For example, the buttons and display screen 32 may be used to adjust or set the time and/or date, or the format of the date i.e. DD/MM/YYYY, for example. To enable such selection operations to be accomplished as simply as possible by the user, in preferred embodiments of the print system of the present invention pictograms are displayed on the display screen 32 that denote the function to be executed if selected by the select button 30. For example, a pictogram of an alphanumeric character displayed so as to be a particularly dark, or in relief, may indicate that the selected data item is to be printed in bold print. Preferably the pictograms are the same as, or similar to, existing pictograms used in existing word processing or other computer programs.

In preferred embodiments of the present invention, users may define their own data items that are to be printed, the defined data items being subsequently stored on either a memory card 34 or the memory unit of the print unit 2, as applicable. To define a data item for printing, individual alphanumeric characters or symbols are selected from a pre-stored menu using the scroll buttons 28;29, select button 30 and display screen 32.

The number of characters and symbols that may be used is potentially quite large and is unlikely to be able to display them all at once on the display screen 32. Therefore, to minimise the number of scrolling and selecting operations the user must perform to select each character or symbol the characters and symbols are arranged in the menu in a particular manner. The characters and symbols are grouped together into subsets according to the type of character or symbol. For example, a subset may comprise of a number of versions of the letter “A”, each one having the various accents applied to it that are used in the various different languages. A further subset may comprise of a number of the letters “E” with such accents also applied and a further subset may also comprise of numeric digits 0-9 and for mathematical symbols, and so on.

Only the first symbol within each subset is displayed on the display screen 32 in a sequential manner when the scroll buttons 28;29 are operated. When the desired type of symbol is displayed the select button 30 is depressed, thus selecting that subset. Subsequent operations of the scroll buttons now cause the individual symbols within that subset to be displayed on the display screen 32. When the desired symbol is displayed a further operation of the select button 30 is executed and the symbol is finally selected and inserted into the user defined data items.

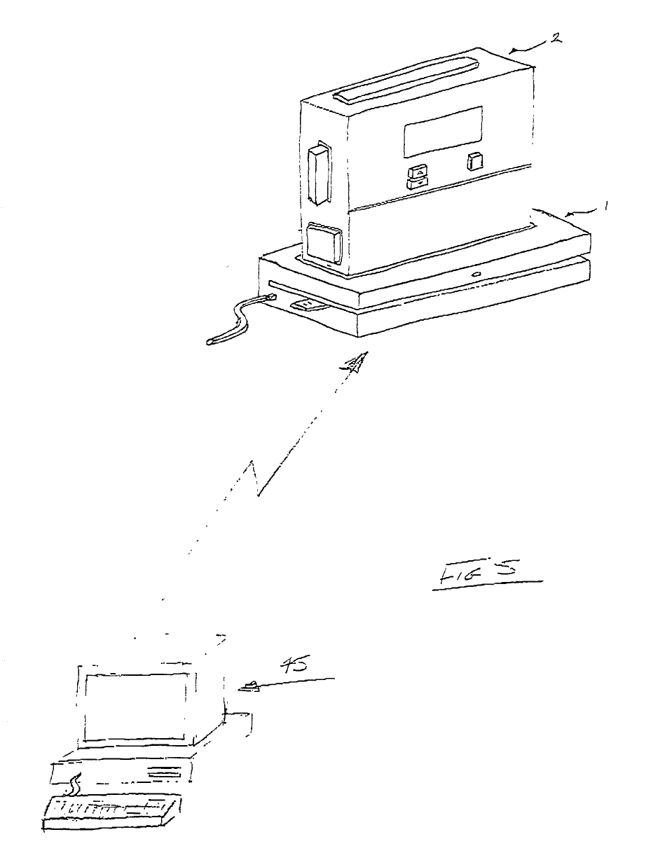

This method of arranging the symbols and selecting them is illustrated diagrammatically in FIG. 4. All the possible symbols are arranged in an array 40, the contents of individual subsets arranged horizontally, and the subset themselves arranged vertically. During the first selecting step only the first symbols 42 from each subset are displayed on the display screen 32. The scroll buttons 28;29 are used to scroll through the symbols in a manner that is analogous to moving vertically through the array 40, as shown by the double headed arrow 44 in FIG. 4. Once the desired subset is selected by operation of the select button 30, the scroll buttons 28;29 scroll through the selected subset in what can be considered a horizontal direction within the array, as shown by the double headed arrow 46. In addition to providing the benefit of reducing a number of scrolling selecting operations required by a user to select a symbol, this method has the further advantage that symbol sets for various different languages can be stored and displayed without any particular bias as to which language is displayed first. That is to say that a user wishing to define a data item in the French language is not required to scroll past all of the symbols that are appropriate to use only in a different language, such as German for example.

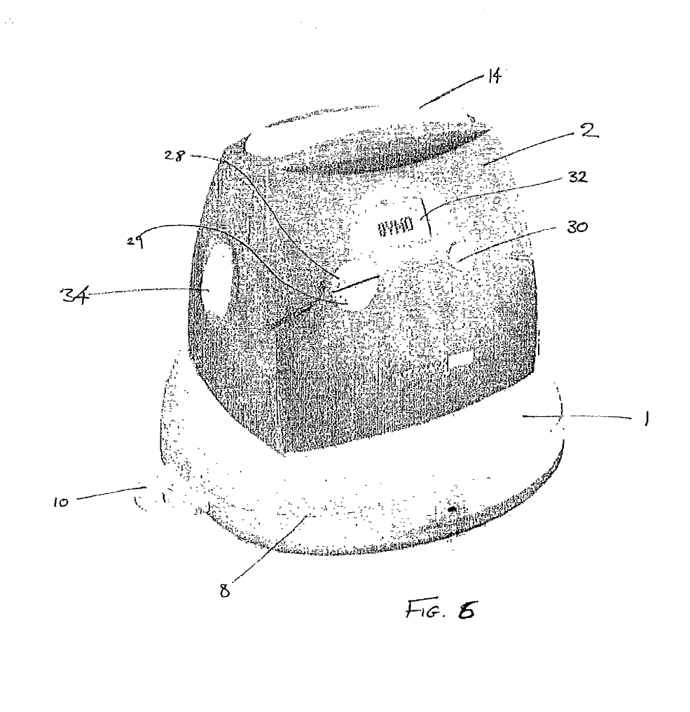

In further embodiments of the present invention the printing system has the additional capability of communicating with an auxiliary image generating processor, such as a desk top PC or the like, as illustrated in FIG. 5. The means for communicating between the processor 45 and the printing system may be any known method such as a cable connection, infrared connection, or radio communications system, such as Bluetooth. The communication means may be connected to either the base station 1 or the print unit 2. In these embodiments the image or data item that is desired to be printed is generated by the processor 45 and transmitted to the print unit 2.

One application for such an arrangement is the generation and printing of a sequence of data items in which only a single piece of information changes between each data item within the sequence. One such example is the generation and printing of bar codes that include a sequentially increasing serial number for an item. In such printing applications it is advantageous to be able to interrupt the printing of the sequence and subsequently resume the printing operation whilst still maintaining the correct sequence of the piece of variable information in each printed data items.

In order to achieve this functionality in embodiments of the present invention either the print unit 2 or the base station 1 includes what will be referred to hereinafter as a counter module. The counter module is operable to maintain a record of the value of the last printed piece of variable data within a sequence of data items and to communicate this information via communication means back to the image generating processor 45. The counter module may comprise a further processor and communication interface (not shown). Communication of the state of the previously printed data variable may be communicated to the image generating processor 45 after each data item in a sequence is printed, or alternatively may be only communicated to the image generating processor 45 whenever the printing of the sequence of data items is interrupted. It will of course be appreciated that other schemes of communicating the information may also be adopted. The communicated information is stored by the image generating processor 45 and is thus available to restart printing of a sequence at the appropriate point after the sequence has been previously interrupted.

As an alternative to the state of the variable data being recorded and communicated, the counter module may simply maintain track of the total number of data items within a sequence that have been printed, this information also being usable by the image generating processor 45 to restart an interrupted sequence at the appropriate point. In this alternative, the printing of any sequence of data items may be interrupted and restarted regardless of the information content of the data items. For example, one such application would be the printing of address details from a database where although the information content of each record in the database differs entirely, as the records are in a structured order then by maintaining a count of the number of records printed an interrupted print operation may be successfully resumed at the correct point.

The above-described embodiments of the present invention thus provide a new and improved printing system that substantially overcomes the existing disadvantages of previously known printing systems.

What is claimed is:

1. A printing system comprising a printer unit having a housing in which a print head is mounted for movement over a print face defined by the housing and a base station arranged to receive said printer unit, said base station having an opening for receiving an image receiving medium, said opening being located within said base station such that at least a portion of said image receiving medium received within said opening is adjacent said print face, wherein a printing operation can be executed when said printer unit is received in said base station.

2. A printing system according to claim 1, wherein said base station comprises a sensor arranged to provide a detection signal in response to an image receiving medium being placed within said opening.

3. A printing system according to claim 2, wherein in response to said detection signal said printer unit executes a printing operation.

4. A printing system according to claim 3, wherein said printing operation is executed a predefined timed time period after said detection signal is provided.

5. A printing system according to claim 2, wherein in response to said detection signal a confirmation signal is provided to indicate that a printing operation may be manually initiated.

6. A printing system according to claim 5, wherein said confirmation signal is a visual signal.

7. A printing system according to claim 5, wherein said confirmation signal is an audio signal.

8. A printing system according to claim 1, wherein said base station comprises an alignment device having alignment guides whereby alignment of the said image receiving medium in said opening with said alignment guides facilitates alignment of said image receiving medium with said print face.

9. A printing system according to claim 8, wherein said alignment device comprises at least two alignment guides whereby each of said alignment guides facilitates alignment of a different sized image receiving medium.

10. A printing system according to claim 1, wherein said printer unit comprises:
a print head cleaning station adjacent said print face whereby in response to a print head cleaning signal said print head may be brought into contact with said cleaning station to clean said print head.

11. A method of selecting a symbol to be printed by a printer unit from a set of symbols, said set of symbols comprising a plurality of subsets of symbol types, each subset comprising a plurality of symbols of one type, the method comprising:
sequentially displaying a first symbol from one or more of said subsets of symbol types and selecting a said subset when a desired symbol type is displayed;
sequentially displaying the symbols comprising said selective subset and selecting a desired symbol to be printed.

12. A method according to claim 11, wherein at least one of said subsets comprises a plurality of alphabetic characters.

13. A method according to claim 11, wherein at least one of said subsets comprises a plurality of numeric characters.

14. A method according to claim 11, wherein at least one of said subsets comprises a plurality of special characters including a number of punctuation symbols and a number of mathematical symbols.

15. A method according to claim 12 wherein each of said alphabetic subsets comprises a plurality of symbols, each symbol being a different representation of the same alphabetic character.

16. A method according to claim 11, wherein said sequential display steps are performed in response to the operation of one or more scroll keys located on said printer unit.

17. A method according to claim 16, wherein two of said scroll keys are provided, a first scroll key causing the sequential display steps to be formed in a first sequence and a second scroll key causing the sequential display steps to be formed in a second sequence.

18. A method according to claim 11, wherein said selecting operations are executed by the activation of a select key located on said printer unit.

19. A printing system comprising a printing unit connected to a print processor, said print processor arranged to generate a sequence of images to be printed, and said printing unit comprising a communication unit operable to communicate to said print processor information relating to the previously printed image whereby said print processor is further operable to store said communicated information in a memory unit wherein if printing of said sequence of images is interrupted printing can be resumed at the point in the sequence at which the interruption occurred.

20. A printing system according to claim 19, wherein said sequence of images includes at least one data item having a value that varies in consecutive images an said sequence in a predefined manner and said information communicated from said printing unit to the print processor comprises the value of said at least one data item.

21. A printing system according to claim 19, wherein said information communicated from said printing unit to the print processor comprises the number of images in said sequence that have been printed.

22. A printing system according to claim 19, wherein said communication unit communicates said information to the print processor after each of said images has been printed.

23. A printing system according to claim 19, wherein said communication unit communicates said information to the print processor whenever printing is interrupted.

24. A printing system comprising a printing unit connected to a print processor, said print processor arranged to generate an image to be printed, said printing unit comprising a communication unit operable to communicate to said print processor timestamp information when said image is printed.

25. A printing system according to claim 24, wherein the processor inserts said communicated timestamp information into said generated image.

26. A printing system according to claim 24, wherein said processor stores said communicated timestamp information as an associated file to said generated image.

27. A printing system according to claim 24, wherein said timestamp information comprises the date when said image is printed.

28. A printing system according to claim 24, wherein said timestamp information comprise the time when said image is printed.

29. A method according to claim 12, wherein at least one of said subsets comprises a plurality of numeric characters.
